(19) United States
(12) Patent Application Publication
(10) Pub. No.: US 2021/0358067 A1
(43) Pub. Date: Nov. 18, 2021

(54) To provide the maximum 10-year holistic Length Of Stay (LOS) in a specialized residential care facility for persons to escape from a volatile domestic violence condition. This visionary concept will adequately rehabilitate and stabilize victims to re-enter society as productive citizens. Disjunct locations will consist of high-rise apartment buildings and living quarters for women, men and their children, respectively

(71) Applicant: Artila Finley, Detroit, MI (US)

(72) Inventor: Artila Finley, Detroit, MI (US)

(21) Appl. No.: 16/872,464

(22) Filed: May 12, 2020

(51) Int. Cl. G06Q 50/26

(52) U.S. Cl. CPC G06Q 50/265

(57) ABSTRACT

I believe lives will be spared by protecting domestically violated victims and their children from harm and or death by providing them a safe and secure environment to strife in. The goal for the victims is to regain independence and a sense of self-worth within the ten-year length of stay. Services available on-site include addiction substance counseling and life coach sessions on an as needed basis. Along with higher education or vocation training victims of domestic violence will become new productive contributing citizens in our society.

To provide the maximum 10-year holistic Length Of Stay (LOS) in a specialized residential care facility for persons to escape from a volatile domestic violence condition. This visionary concept will adequately rehabilitate and stabilize victims to re-enter society as productive citizens. Disjunct locations will consist of high-rise apartment buildings and living quarters for women, men and their children, respectively. These buildings and living quarters will be fortified, heavily secured, consistently monitored by cameras and equipped with a sophisticated system for resident and visitor entry. Visitor accessibility is restricted to biological and stepfamily members only, provided the resident has submitted copies of legal documents for identification purposes. These copies must be retained on file. Visitors per resident is limited to Federal, State and Local safety codes. Vehicle, body and personal items scans must be conducted before entry into apartments and living quarters are permitted for both residents and visitors. All medically prescribed medicines for residents must be included in their personal files. No one who is intoxicated will be permitted on the premise.

### CROSS REFERENCE TO RELATED APPLICATIONS

(Not applicable)

### STATEMENT REGARDING FEDERALLY SPONSORED RESEARCH OR DEVELOPMENT

(Not applicable)

### REFERENCE TO SEQUENCE LISTING, A TABLE, OR A COMPUTER PROGRAM LISTING COMPACT DISC APPENDIX

(Not applicable)

### BACKGROUND OF THE INVENTION

There were 91,004 reported victims and 105 reported murders related to domestic violence in 2017 [The Michigan State Police Crime in Michigan]. I suppose these astonishing statistics would make one wonder what is occurring in the other 49 states. Our society must be made accountable for and responsible to prevent fatal as well as non-fatal domestic violence conditions from happening. This “paradigm shift” concept intent to intervene; by making the necessary investments to preserve lives which will ultimately produce outstanding citizens who will re-enter and give back to our society.

### BRIEF SUMMARY OF THE INVENTION

To provide the maximum ten-year LOS living arrangement for persons to escape volatile domestic violence conditions. They must be placed in a safe location where they will be holistically healed from the damages of an unlivable environment.

### BRIEF DESCRIPTION OF THE SEVERAL VIEWS OF THE DRAWING

FIG. 1A—An aerial view of apartment buildings for women and children residents

FIG. 1B—Fortified high wall surrounding buildings, parking structure, body and personal item scan equipment and Conference Center.

FIG. 1C—Voice activated and camera surveillance area. Residents and staff members entry area. Only visitors who are biological and step family members are allowed on the premise. Legal documents for them must be already on file to enter this area.

FIG. 1D—All vehicles must pass the inspection of 3DX-RAY scanner equipment.

FIG. 1E—All vehicles that pass inspection are granted access to proceed further.

FIG. 1F—All vehicles that do not pass inspection must exit unto the street.

FIG. 1G—Resident and staff member can enter the gated premise to the parking structure. Visitors can proceed to their parking lot located outside of the walls of the premise.

FIG. 1H—Residents and staff members can proceed to the body and personal item scan area.

FIG. 1I—Visitors can proceed to a walled area leading to the body and personal scan area.

FIG. 1J—Residents, staff members and visitors can proceed to Bldg A or Bldg B which correspond to their apartment, working location or visiting apartments respectively.

FIG. 1K—Conference Center for resident meetings, drug/alcohol meetings and life coach meetings as needed and scheduled.

FIG. 2A—Aerial view of men's living quarters.

FIG. 2B—Fortified impenetrable high wall surrounding living quarters, parking structure, body and personal property scan area and Conference Center.

FIG. 2C—Voice activated and camera surveillance area. Residents and staff members entry area. Only visitors who are biological and step family members are allowed on the premise. Legal documents for them must be already on file to enter this area.

FIG. 2D—All vehicles must pass the inspection of 3DX-RAY scanner equipment.

FIG. 2E—All vehicles that pass inspection are granted access to proceed further.

FIG. 2F—All vehicles that do not pass inspection must exit unto the street.

FIG. 2G—Resident and staff member can enter the gated premise to the parking structure. Visitors can proceed to their parking lot located outside of the walls of the premise.

FIG. 2H—Residents and staff members can proceed to the body and personal item scan area.

FIG. 2I—Visitors can proceed to a walled area leading to the body and personal scan area.

FIG. 2J—Residents, staff members and visitors can proceed to the men's living quarters.

FIG. 2K—Conference Center for resident meetings, drug/alcohol meetings and life coach meetings as needed and scheduled.

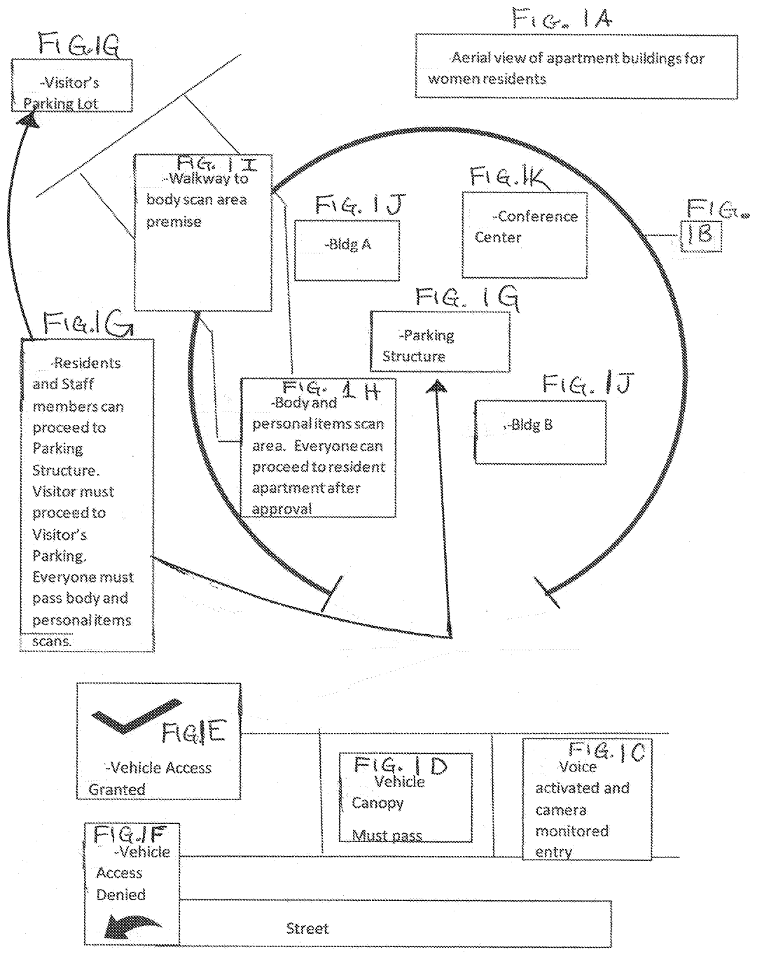

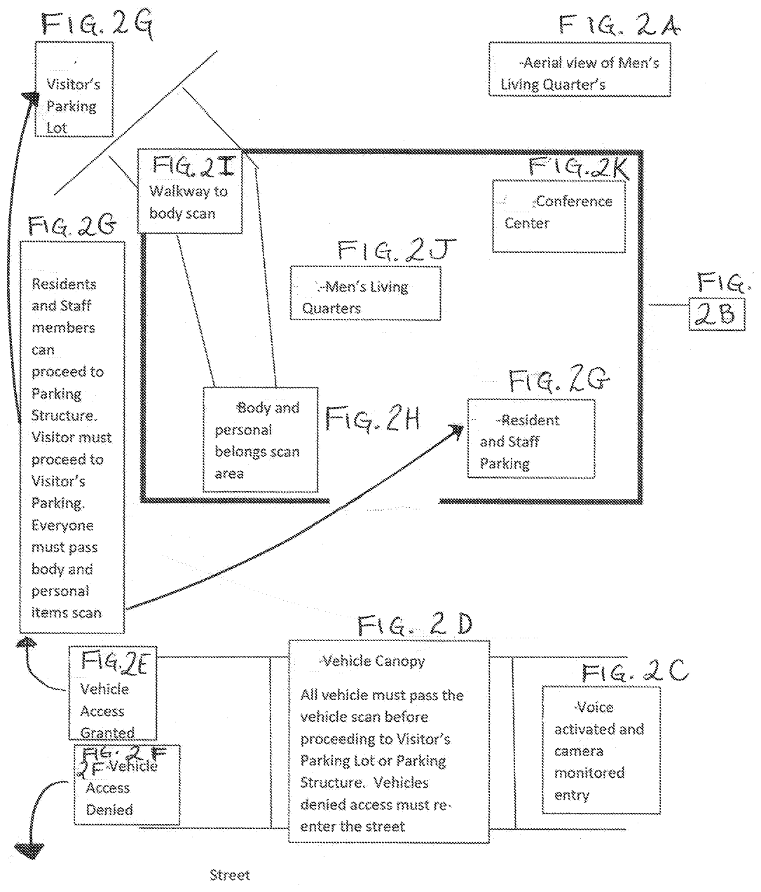

### DETAILED DESCRIPTION OF THE INVENTION

In collaboration with local and state police forces, complainants of domestic violence are afforded the opportunity to be immediately transported to a facility upon their approval. However, if they prefer to return to a volatile environment to face possible devastating harm, their wish will be granted.

### DRAWINGS

Attached on a separate document.

### OATH OR DECLARATION

### Sequence Listing

(Not applicable)

1. In essence, the ten-year length of stay apartments and living quarters is meant to revolutionize the domestic violence shelter concept. These new living arrangements must be viewed from the perspective of the paradigm shift theory. A three to six-month LOS in a domestic violence shelter is not ample time to revitalize and stabilize domestic victim lives. This visionary concept can be viewed from the perspective of the invention of the telephone. Alexander Graham Bell is credited for the first telephone; Martin Cooper made a paradigm shift to the mobile phone then Steve Jobs made an additional one to the IPhone. Our society will only progress provided it is willing to make necessary changes for its betterment. We must continuously invent and invest in new methods of dealing with antiquated ideologies.
